(19) United States
(12) Patent Application Publication
(10) Pub. No.: US 2014/0071228 A1
(43) Pub. Date: Mar. 13, 2014

(54) COLOR CORRECTION APPARATUS FOR PANORAMA VIDEO STITCHING AND METHOD FOR SELECTING REFERENCE IMAGE USING THE SAME

(71) Applicants: National University of Sciences & Technology(NUST), Islamabad (PK); Electronics and Telecommunications Research Institute, Daejeon (KR)

(72) Inventors: Yong Ju CHO, Seoul (KR); Myung Seok KI, Daejeon-si (KR); Joo Myoung SEOK, Daejeon-si (KR); Seong Yong LIM, Daejeon-si (KR); Ji Hun CHA, Daejeon-si (KR); Rehan HAFIZ, Islamabad (PK); Muhammad Murtaza KHAN, Islamabad (PK); Mahammad Twaha IBRAHIM, Islamabad (PK); Arshad ALI, Islamabad (PK)

(73) Assignees: National University of Sciences & Technology(NUST), Islamabad (PK); Electronics and Telecommunications Research Institute, Daejeon (KR)

(21) Appl. No.: 14/024,877

(22) Filed: Sep. 12, 2013

(30) Foreign Application Priority Data
Sep. 12, 2012 (KR) 10-2012-0100817
Sep. 11, 2013 (KR) 10-2013-0109111

(51) Int. Cl. H04N 5/232

(52) U.S. Cl. CPC H04N 5/23238
USPC 348/36

(57) ABSTRACT

Disclosed are a color correction apparatus for panorama video stitching and a method of selecting a reference image using the same. A method of selecting a reference image for color correction when stitching panorama video based on input images includes selecting an optimum reference image candidate from the input images based on standard deviations for overlapping regions between the input images, performing color correction on the input images based on the optimum reference image candidate, and validating the optimum reference image candidate based on the color-corrected input images.

### CROSS-REFERENCE TO RELATED APPLICATIONS

This application claims the benefit of priority of Korean Patent Application No. 10-2012-0100817 filed on Sep. 12, 2012 and Korean Patent Application No. 10-2013-0109111 filed on Sep. 11, 2013, all of which are incorporated by reference in its entirety herein.

### BACKGROUND OF THE INVENTION

1. Field of the Invention

The present invention relates to the color correction of panorama video and, more particularly, to selecting a reference image for the color correction of panorama video.

2. Related Art

Panorama video is generated using several sheets of images. Quality of the panorama video is significantly deteriorated if color correction is not performed when generating the panorama video because images have a color difference although the images have been captured by the same camera.

FIG. 1 shows an example of panorama video. FIG. 1(a) shows panorama video before color correction when generating the panorama video, and FIG. 1(b) shows panorama video after color correction when generating the panorama video.

The panorama video of FIG. 1(a) reveals that color has been distorted due to a color difference between an image on the left side and an image on the right side.

The panorama video of FIG. 1(b) reveals that a color distortion phenomenon has been removed through color correction.

A color correction procedure involves selecting a reference image I_{Ref} and generating panorama video by controlling the colors of the remaining images on the basis of the color of the selected reference image. If an image having low brightness and contrast is selected as a reference image, panorama video has low brightness and contrast. As a result, quality of the panorama video is deteriorated even after color correction. The selection of a reference image from several sheets of input images has a great influence on quality of panorama video.

Accordingly, when generating (stitching or registering) panorama video, there is a need for a method and apparatus for automatically selecting an optimum reference image from several sheets of input images in a color correction process.

### SUMMARY OF THE INVENTION

The present invention provides a method and apparatus for selecting an optimum reference image for panorama video stitching.

The present invention provides a method and apparatus for selecting an optimum reference image and correcting the color of panorama video using the selected reference image.

In accordance with an aspect of the present invention, there is provided a method of selecting a reference image for color correction when stitching panorama video based on input images, including selecting an optimum reference image candidate from the input images based on standard deviations for overlapping regions between the input images, performing color correction on the input images based on the optimum reference image candidate, and validating the optimum reference image candidate based on the color-corrected input images.

The validating of the optimum reference image candidate may include deriving a comparison value between the color-corrected input images and the input images prior to the color correction and determining the optimum reference image candidate to be a final reference image depending on whether or not the comparison value satisfies a predetermined threshold. The comparison value may include at least one of a contrast value, an edge preservation value, and a value indicative of a percentage change in a saturation of color between the color-corrected input images and the input images prior to the color correction.

The method may further include selecting a next optimum reference image candidate from the input images based on the standard deviation if, as a result of the determination, it is determined that the comparison value does not satisfy the predetermined threshold.

The method may further include changing the predetermined threshold if the final reference image is not present in the input images and deriving the final reference image based on the changed threshold.

The selecting of the optimum reference image candidate may include calculating a standard deviation for an overlapping region between two neighboring input images after geometric correction is performed on the input images, calculating a standard deviation difference value for each of the input images based on the standard deviation, and ranking the suitability of the input images for selecting the optimum reference image candidate based on the standard deviation difference value.

The selecting of the optimum reference image candidate may include selecting an input image having a maximum value, from among the standard deviation difference values for the input images, as the optimum reference image candidate.

The ranking of the suitability of the input images may include determining order of the suitability of the input images in descending powers of the standard deviation difference values.

The input images may include images having different views obtained by multiple cameras.

In accordance with another aspect of the present invention, there is provided a color correction apparatus for performing color correction when stitching panorama video based on input images, including a reference image candidate selection module for selecting an optimum reference image candidate from the input images based on standard deviations for overlapping regions between the input images, a color correction module for performing color correction on the input images based on the optimum reference image candidate, and a reference image candidate validation module for validating the optimum reference image candidate based on the color-corrected input images.

The reference image candidate validation module may derive a comparison value between the color-corrected input images and the input images prior to the color correction and determine the optimum reference image candidate to be a final reference image depending on whether or not the comparison value satisfies a predetermined threshold. The comparison value may include at least one of a contrast value, an edge preservation value, and a value indicative of a percentage change in a saturation of color between the color-corrected input images and the input images prior to the color correction.

The reference image candidate validation module may select a next optimum reference image candidate from the input images based on the standard deviation if, as a result of the determination, it is determined that the comparison value does not satisfy the predetermined threshold.

The reference image candidate validation module may change the predetermined threshold if the final reference image is not present in the input images and derives the final reference image based on the changed threshold.

The reference image candidate selection module may calculate a standard deviation for an overlapping region between two neighboring input images after geometric correction is performed on the input images, calculate a standard deviation difference value for each of the input images based on the standard deviation, and rank the suitability of the input images for selecting the optimum reference image candidate based on the standard deviation difference value.

The reference image candidate selection module may select an input image having a maximum value, from among the standard deviation difference values for the input images, as the optimum reference image candidate.

The reference image candidate selection module may determine order of the suitability of the input images in descending powers of the standard deviation difference values.

The input images may include images having different views obtained by multiple cameras.

### BRIEF DESCRIPTION OF THE DRAWINGS

FIG. 1 shows an example of panorama video;

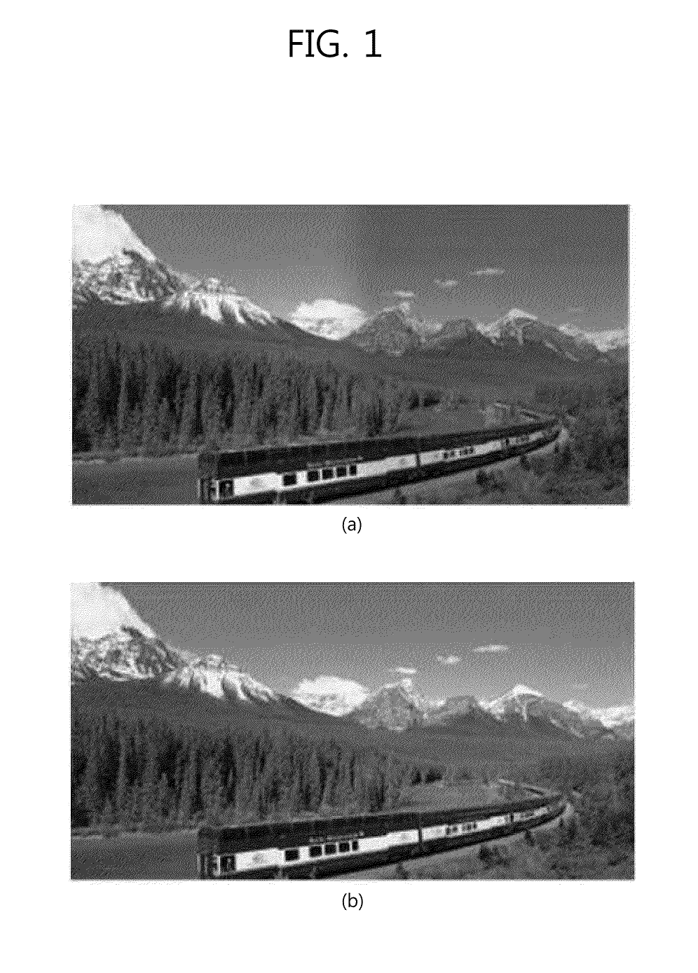

FIG. 2 is a flowchart schematically showing a method of selecting a reference image for color correction when generating (stitching or registering) panorama video in accordance with an embodiment of the present invention;

FIG. 3 is a diagram illustrating a process of stitching panorama video based on a plurality of input images;

FIG. 4 is a flowchart showing an example of a method of selecting a reference image for color correction when generating (stitching or registering) panorama video in accordance with an embodiment of the present invention;

FIG. 5 is a diagram showing panorama video whose color has been corrected by a reference image;

FIG. 6 is a block diagram schematically showing a color correction apparatus for performing color correction using a reference image when generating (stitching or registering) panorama video in accordance with an embodiment of the present invention; and

FIG. 7 is a diagram showing panorama video whose color has been corrected depending on the selection of a reference image.

### DESCRIPTION OF EXEMPLARY EMBODIMENTS

Hereinafter, exemplary embodiments of the present invention are described in detail with reference to the accompanying drawings. In describing the embodiments of the present invention, a detailed description of the known functions and constructions will be omitted if it is deemed to make the gist of the present invention unnecessarily vague.

In this specification, when it is said that one element is ‘connected’ or ‘coupled’ with the other element, it may mean that the one element may be directly connected or coupled with the other element or a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element units described in the embodiments of the present invention are independently shown in order to indicate different and characteristic functions, and it does not mean that each of the element units is formed of a piece of separated hardware or a piece of software. That is, the element units are arranged and included, for convenience of description, and at least two of the element units may form one element unit or one element may be divided into a plurality of element units and the plurality of element units may perform functions. An embodiment into which the elements are integrated or embodiments from which some elements are separated are also included in the scope of the present invention unless they depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

Panorama video can be generated by stitching a plurality of images obtained by multiple cameras. A color difference may be between the plurality of images, and thus the panorama video may be distorted. In order to correct the color difference between the plurality of images, it is important to select a reference image that is a basis. Hereinafter, the present invention provides a method and apparatus capable of improving quality of panorama video by selecting an optimum reference image from a plurality of images and performing color correction on the panorama video.

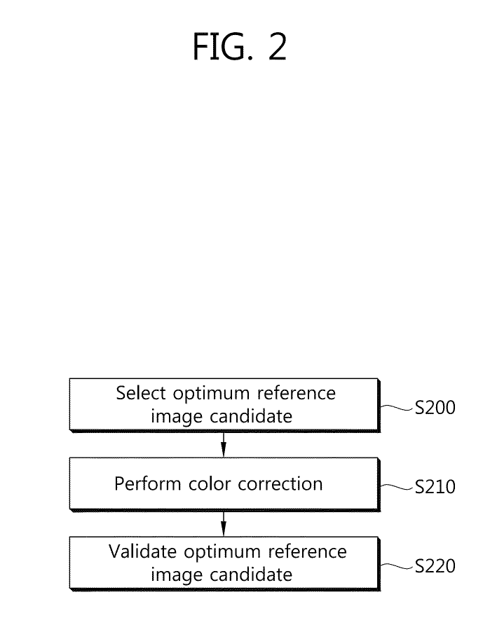

FIG. 2 is a flowchart schematically showing a method of selecting a reference image for color correction when generating (stitching or registering) panorama video in accordance with an embodiment of the present invention. The method of FIG. 2 can be executed by a color correction apparatus to be described later in accordance with the present invention.

Referring to FIG. 2, the color correction apparatus selects an optimum reference image candidate from input images for panorama video stitching at step S200. Here, the optimum reference image candidate can be selected based on a standard deviation for an overlapping region between the input images.

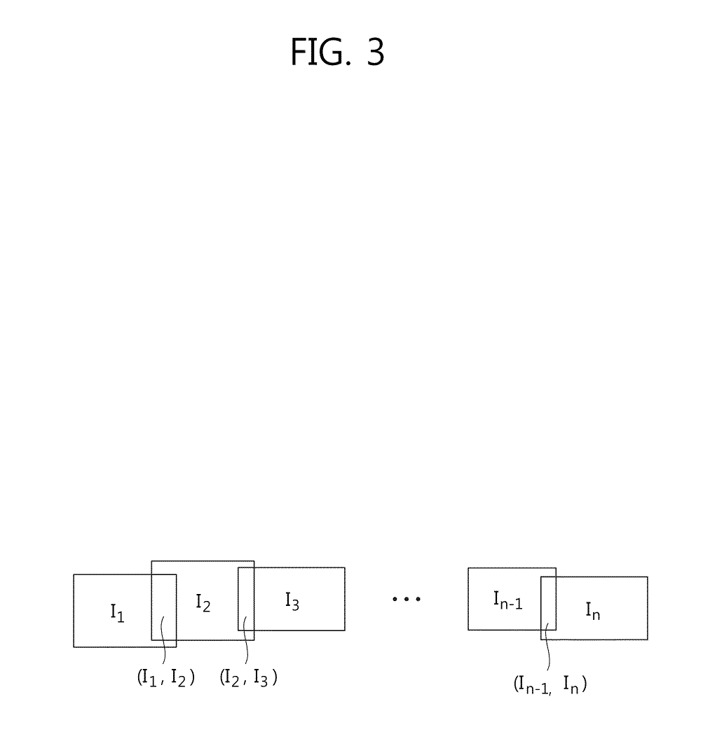

For example, it is assumed that panorama video is generated using n input images obtained at different views. As shown in FIG. 3, n input images I₁, I₂, . . . , Iₙ may include n images from the very left image I₁ to the very right image Iₙ within the panorama video through geometric correction. Here, an overlapping region is present between two neighboring images of the geometrically corrected input images I₁, I₂, . . . , Iₙ. For example, Iᵢ₋₁, Iᵢ may mean an overlapping region between two neighboring images Iᵢ₋₁ and Iᵢ after geometric correction (wherein i=2, 3, . . . , n).

A standard deviation σ_{i-1,i} for the overlapping region Iᵢ₋₁, Ii between the two neighboring images Iᵢ₋₁ and Iᵢ can be calculated as in Equation 1 below. Equation 1 shows a standard deviation for R, G, B colors in the overlapping region between the Iᵢ₋₁ image and the Iᵢ image.

$${σ}_{i - 1 , i} = \{ \begin{matrix}{σ}_{i - 1} \\ {σ}_{i}\end{matrix} \} = \{ \begin{matrix}{σ}_{i - 1}^{R} & {σ}_{i - 1}^{G} & {σ}_{i - 1}^{B} \\ {σ}_{i}^{R} & {σ}_{i}^{G} & {σ}_{i}^{B}\end{matrix} \} \qquad [ Equation 1 ]$$

In Equation 1, σᵢ^{k} means a standard deviation for a K color of the Iᵢ image.

In accordance with an embodiment of the present invention, in order to select an optimum reference image from the input images I₁, I₂, . . . , Iₙ, a standard deviation difference value for the input images I₁, I₂, . . . , Iₙ can be calculated based on the standard deviation σ_{i-1,i} for the overlapping region between input images, which has been calculated using Equation 1, as in Equation 2 below.

$${D}_{i} = \{ {D}_{i - 1} + sum ( ( \frac{{σ}_{i - 1 , i , 2}^{j} - {σ}_{i - 1 , i , 1}^{j}}{{σ}_{i - 1 , i , 1}^{j}} ) \times 100 ) \} \\ 2 \leq i \leq n , j ∈ R , G , B \qquad [ Equation 2 ]$$

In Equation 2, σ_{i-1,i,1}ⁱ means a standard deviation for a j color of the image, and σ_{i-1,i,2}ⁱ means a standard deviation for a j color of the Iᵢ image. D₀, that is, a standard deviation difference value for the very left image I₁ within the panorama video, can be assumed to be 0. For example, if the number of input images is 5, standard deviation difference values for the respective input images can be calculated as D₁ to D₅. D₅ can be a value obtained by adding the sum of D₁ to D₄ and a standard deviation difference calculated in the overlapping region Iᵢ₋₁, Iᵢ between the I₄ image and the I₅ image.

The color correction apparatus can select an optimum reference image candidate based on the standard deviation difference values for the respective input images calculated by Equation 1 and Equation 2. For example, an input image having the greatest standard deviation difference value may be selected as the optimum reference image candidate.

For example, the color correction apparatus can rank the suitability of the input images for selecting the optimum reference image candidate based on the standard deviation difference values for the input images. For example, an input image having the greatest standard deviation difference value may be ranked as a reference image candidate having the highest suitability, and an input image having the smallest standard deviation difference value may be ranked as a reference image candidate having the lowest suitability. Order that an input image is selected as an optimum reference image candidate can be determined based on the suitability ranks of the input images. For example, an input image having the highest suitability may be selected as an optimum reference image candidate, and step S210 and step S220 may be performed on the optimum reference image candidate. If, as a result of step S220, the selected optimum reference image candidate is not determined to be the final reference image, a next optimum reference image candidate may be selected according to determined order based on the suitability ranks, and step S210 and step S220 may be performed on the next optimum reference image candidate.

The color correction apparatus performs color correction on the input images using the optimum reference image candidate at step S210. The colors of the remaining input images can be corrected based on the optimum reference image candidate.

Here, a variety of color correction methods can be used. For example, a global color correction method of applying one function to the entire image may be used, or a local color correction method of applying different functions to portions of an image may be used. In another embodiment, a parametric-based color correction method of correcting the color of an image using one equation may be used, or a non-parametric-based color correction method of correcting the color of an image using a mapping table, such as a Look-Up Table (LUT), may be used.

The color correction apparatus validates the optimum reference image candidate using input images whose colors have been corrected at step S220. That is, the color correction apparatus validates whether or not to use the optimum reference image candidate as the final reference image candidate based on a comparison value that is obtained by comparing the input images on which color correction has been performed at step S210 (hereinafter referred to as color-corrected input images) with the input images prior to color correction (hereinafter referred to as original input images).

More particularly, the color correction apparatus can derive the comparison value between the color-corrected input images and the original input images. The comparison value can be at least one of a contrast value, an edge preservation value, and a value indicative of a percentage change in the saturation of color between the color-corrected input images and the original input images.

The edge preservation value can indicate the degree of preservation of an object edge within the panorama video. For example, the edge preservation value may be derived using a comparison value, such as luminance, contrast, or a structure, between the original input images and the color-corrected input images. For example, a comparison value, such as luminance, contrast, or a structure, may be obtained using an image gradient map instead of the original input images.

The value indicative of a percentage change in the saturation of color can be a value indicated using a change in the number of pixels saturated in the color-corrected input image, as compared with the original input image, as a percentage. Here, the saturated pixel refers to a pixel having a pixel value smaller than 1 or a pixel value greater than 255.

The color correction apparatus determines whether or not the comparison value satisfies a predetermined threshold and may determine the optimum reference image candidate, selected at step S200, to be the final reference image based on a result of the determination. If, as a result of the determination, it is determined that the comparison value does not satisfy the predetermined threshold, the color correction apparatus may select a next optimum reference image candidate from the input images based on the standard deviation difference values and validate the next optimum reference image candidate. If the final reference image is not derived through the above-described process, that is, if any optimum reference image candidate does not satisfy the predetermined threshold, the color correction apparatus may change the predetermined threshold and validate an optimum reference image candidate based on the changed threshold.

For example, if an optimum reference image candidate is to be validated using an edge preservation value between the original input images and the color-corrected input images, the color correction apparatus may determine whether or not the edge preservation value is greater than a predetermined threshold.

If, as a result of the determination, it is determined that the edge preservation value is greater than the predetermined threshold, the color correction apparatus may select a current optimum reference image candidate as the final reference image. If, as a result of the determination, it is determined that the edge preservation value is equal to or smaller than the predetermined threshold, the color correction apparatus may select a next optimum reference image candidate not a current optimum reference image candidate and perform step S210 and step S220 on the next optimum reference image candidate. The next optimum reference image candidate, as described above, may be an input image having higher suitability next to a current optimum reference image candidate according to the rank suitability based on the standard deviation difference values of the input images.

The color correction apparatus repeatedly performs the above-described process until an optimum reference image candidate having an edge preservation value greater than a predetermined threshold is found. If any optimum reference image candidate having an edge preservation value greater than the predetermined threshold is not found, the color correction apparatus may change the predetermined threshold for the edge preservation value and repeatedly perform the above-described process using the changed threshold.

For another example, if an optimum reference image candidate is to be validated using a value indicative of a percentage change in the saturation of color between the original input images and the color-corrected input images, the color correction apparatus may determine whether or not the value indicative of a percentage change in the saturation of color is smaller than a predetermined threshold.

If, as a result of the determination, it is determined that the value indicative of a to percentage change in the saturation of color is smaller than the predetermined threshold, the color correction apparatus may select a current optimum reference image candidate as the final reference image. If, as a result of the determination, it is determined that the value indicative of a percentage change in the saturation of color is equal to or greater than the predetermined threshold, the color correction apparatus may select a next optimum reference image candidate not a current optimum reference image candidate and perform step S210 and step S220 on the next optimum reference image candidate.

Furthermore, as described above, the color correction apparatus repeatedly performs the above-described process until an optimum reference image candidate that has a value indicative of a percentage change in the saturation of color smaller than the predetermined threshold is found. If any optimum reference image candidate that has a value indicative of a percentage change in the saturation of color smaller than the predetermined threshold is not found, the color correction apparatus may change the predetermined threshold for a value indicative of a percentage change in the saturation of color and repeatedly perform the above-described process using the changed threshold.

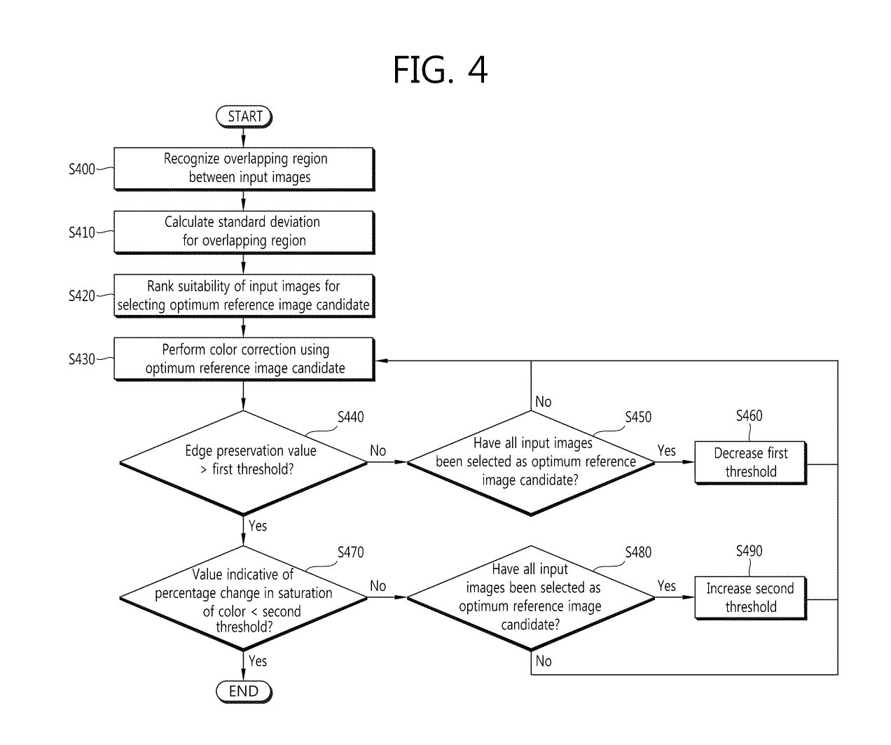

Although a process of validating an optimum reference image candidate using an edge preservation value or a value indicative of a percentage change in the saturation of color has been illustrated in the above examples, the present invention is not limited to the examples. For example, an optimum reference image candidate may be validated using both an edge preservation value and a value indicative of a percentage change in the saturation of color, which is described in detail with reference to FIG. 4.

FIG. 4 is a flowchart showing an example of a method of selecting a reference image for color correction when generating (stitching or registering) panorama video in accordance with an embodiment of the present invention. The method of FIG. 4 can be executed by the color correction apparatus to be described later in accordance with the present invention.

Referring to FIG. 4, the color correction apparatus recognizes an overlapping region between input images for panorama video stitching at step S400.

When generating panorama video using n input images obtained at different views as described above, an overlapping region is present between neighboring images of the n input images after geometric correction. Accordingly, the color correction apparatus can detect overlapping regions between two neighboring input images of the geometrically corrected n input images.

The color correction apparatus calculates a standard deviation for each of the overlapping regions between the n input images at step S410. The standard deviation for the overlapping region can be calculated as in Equation 1.

The color correction apparatus ranks the suitability of the n input images based on the standard deviations for the overlapping regions in order to select an optimum reference image candidate at step S420.

The suitability of the n input images can be ranked by calculating standard deviation difference values for the respective n input images using the standard deviations for the overlapping regions. The standard deviation difference value for the input image can be calculated as in Equation 2.

For example, an input image having the greatest standard deviation difference value may be ranked as a reference image candidate having the highest suitability, or an input image having the smallest standard deviation difference value may be ranked as a reference image candidate having the lowest suitability. Order that an input image is selected as an optimum reference image candidate can be determined based on the suitability ranks of the n input images.

The color correction apparatus performs color correction on the n input images using the selected optimum reference image candidate based on the suitability ranks of the n input images at step S430.

Here, the colors of the remaining input images can be corrected based on the color of the optimum reference image candidate using a variety of color correction methods as described above. For example, a global color correction method, a local color correction method, a parametric-based color correction method, or a non-parametric-based color correction method can be used to correct the colors of the remaining input images.

The color correction apparatus can validate whether or not to use the optimum reference image candidate as the final reference image candidate based on a comparison value obtained by comparing color-corrected input images with the original input images. For example, according to an embodiment, a process of deriving an edge preservation value and a value indicative of a percentage change in the saturation of color as comparison values and validating a result of the color correction for panorama video based on the comparison values is described below.

The color correction apparatus compares color-corrected input images, obtained at step S430, with the original input images, derives an edge preservation value based on a result of the comparison, and determines whether or not the edge preservation value satisfies a first threshold for the edge preservation value (i.e., whether or not the edge preservation value is greater than the first threshold) at step S440.

The edge preservation value, as described above, indicates the degree of preservation of an object edge. The edge preservation value can be calculated by performing a brightness comparison, a contrast comparison, or a structure comparison between the original input images and the color-corrected images. In another embodiment, the edge preservation value based on a gradient for the color-corrected input images may be derived using a gradient map.

If, as a result of the determination at step S440, it is determined that the edge preservation value does not satisfy the first threshold (i.e., the edge preservation value is equal to or smaller than the first threshold), that is, if the validation of the color-corrected input images fails using a current selected optimum reference image candidate, the color correction apparatus determines whether or not each of the n input images has been selected as an optimum reference image candidate at step S450.

If, as a result of the determination, it is determined that each of all the n input images has been selected as an optimum reference image candidate, that is, if any optimum reference image candidate selected from the n input images does not satisfy the first threshold, the color correction apparatus changes the first threshold at step S460. For example, the color correction apparatus may decrease (e.g., decrease by about 5%) the first threshold. Next, the color correction apparatus may select an optimum reference image candidate from the n input images again and perform the above-described process using the changed first threshold.

If, as a result of the determination at step S450, it is determined that all the n input images have not been selected as an optimum reference image candidate, the color correction apparatus may select an optimum reference image candidate from input images not selected as an optimum reference image candidate and repeatedly perform the above-described steps S430, S440, and S450.

If, as a result of the determination at step S440, it is determined that the edge preservation value satisfies the first threshold (i.e., if the edge preservation value is greater than the first threshold), the color correction apparatus compares the color-corrected input images, obtained at step S430, with the original input images, derives a value indicative of a percentage change in the saturation of color based on a result of the comparison, and determines whether or not the value indicative of a percentage change in the saturation of color satisfies a predetermined second threshold at step S470.

The value indicative of a percentage change in the saturation of color, as described above, can be a value indicated using a change in the number of pixels saturated in the color-corrected input image, as compared with the original input image, as a percentage.

If, as a result of the determination at step S470, it is determined that the value indicative of a percentage change in the saturation of color does not satisfy the second threshold (i.e., if the value indicative of a percentage change in the saturation of color is equal to or greater than the second threshold), that is, if the validation of the color-corrected input images using a current selected optimum reference image candidate fails, the color correction apparatus determines whether or not each of all the n input images has been selected as an optimum reference image candidate at step S480.

If, as a result of the determination at step S480, it is determined that all the n input images has been selected as an optimum reference image candidate, that is, if any optimum reference image candidate selected from the n input images does not satisfy the second threshold, the color correction apparatus changes the second threshold at step S490. For example, the color correction apparatus may increase (e.g., increase by about 5%) the second threshold. Next, the color correction apparatus may select an optimum reference image candidate from the n input images again and perform the above-described process using the changed second threshold.

If, as a result of the determination at step S480, it is determined that all the n input images have not been selected as an optimum reference image candidate, the color correction apparatus may select an optimum reference image candidate from input images not selected the optimum reference image candidate and repeatedly perform the above-described process on the optimum reference image candidate.

If, as a result of the determination at step S470, it is determined that the value indicative of a percentage change in the saturation of color satisfies the second threshold (i.e., if the value indicative of a percentage change in the saturation of color is smaller than the second threshold), the color correction apparatus can determine a current selected optimum reference image candidate as the final reference image candidate.

An example in which panorama video is generated using five input images is described below in connection with an embodiment of the method of selecting a reference image according to the present invention.

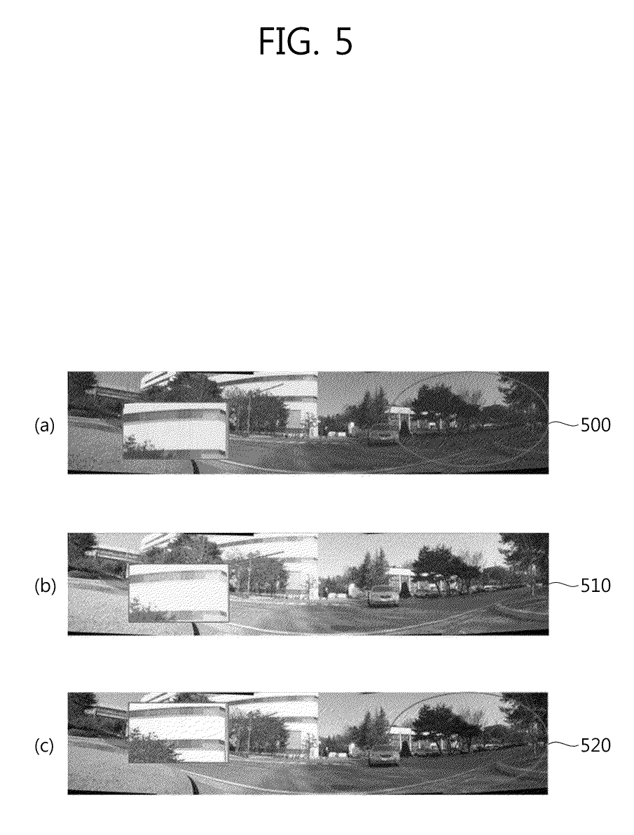

Table 1 shows an example of standard deviation difference values D, standard deviations (Panorama STDs) for RGB colors, edge preservation values (GSSIM), and values indicative of a percentage change in the saturation of color (ΔS % age) for the five input images I₁, I₂, I₃, I₄, and I₅. Furthermore, Table 1 show values obtained through an experiment process of generating panorama video of FIG. 5 using the five input images I₁, I₂, I₃, I₄, and I₅.

TABLE 1

| | | GSSIM | | | | | | ΔS_{% age} | | | | | Panorama STDs | | |
|---|---|---|---|---|---|---|---|---|---|---|---|---|---|---|---|
| Images | D | Ref | I₁ | I₂ | I₃ | I₄ | I₅ | I₁ | I₂ | I₃ | I₄ | I₅ | R | G | B |
| I₁ | 0 | I₁ | 1 | 0.99 | 0.99 | 0.92 | 0.87 | 0 | −.05 | −.05 | −.11 | −1.6 | 11.99 | 10.17 | 9.89 |
| I₂ | 9.03 | I₂ | 0.99 | 1 | 0.98 | 0.98 | 0.96 | 0.23 | 0 | −3.7 | −.11 | −1.5 | 12.68 | 10.43 | 9.80 |
| I₃ | 5.32 | I₃ | 0.99 | 0.99 | 1 | 0.95 | 0.87 | 0 | −.05 | 0 | −.11 | −1.5 | 12.80 | 10.39 | 9.63 |
| I₄ | 107.15 | I₄ | 0.95 | 0.96 | 0.96 | 1 | 0.97 | 1.2 | 2.4 | 14.5 | 0 | −1.5 | 10.99 | 11.38 | 13.84 |
| I₅ | 140.76 | I₅ | 0.89 | 0.91 | 0.87 | 0.97 | 1 | 0.48 | 1.7 | 19.4 | 6.5 | 0 | 10.14 | 10.95 | 13.29 |

Referring to Table 1, a standard deviation difference value D and a standard deviation (Panorama STDs) for RGB colors for each of the input images I₁, I₂, I₃, I₄, and I₅ can be calculated using Equation 1 and Equation 2.

The edge preservation value (GSSIM) and the value indicative of a percentage change in the saturation of color value (ΔS % age) can be calculated by comparing a color-corrected image with the original image based on a reference image when each of the input images I₁, I₂, I₃, I₄, and I₅ is selected as the reference image.

If the method of selecting a reference image according to the present invention is applied according to the results of Table 1, order that an input image is selected as an optimum reference image candidate can be determined based on the standard deviation difference values D for the input images I₁, I₂, I₃, I₄, and I₅. For example, order that an input image is selected as an optimum reference image candidate can be determined in descending powers of the standard deviation difference values D. In accordance with the results of Table 1, the optimum reference image candidates may be selected in order of the input images I₅, I₄, I₂, I₃, and I₁.

For example, if thresholds for the edge preservation value and the value indicative of a percentage change in the saturation of color value, respectively, are set to 0.95 and 15%, the input image I₅ can be first selected as an optimum reference image candidate having the greatest standard deviation difference value D according to the method of FIG. 4. Here, since an edge preservation value and a value indicative of a percentage change in the saturation of color between the color-corrected image and the original image using the input image I₅ do not satisfy the set thresholds as shown in Table 1, the input image I₄ having the second greatest standard deviation difference value D can be selected as an optimum reference image candidate. Since an edge preservation value and a value indicative of a percentage change in the saturation of color between the color-corrected image and the original image using the input image I₄ satisfy the set thresholds, the optimum reference image candidate I₄ can be determined to be the final reference image.

If thresholds for the edge preservation value and the value indicative of a percentage change in the saturation of color value are set to 0.95 and 15% as described above, panorama video on which color correction was performed using the input images I₁, I₄, and I₅ as reference images is shown in FIG. 5.

FIG. 5(a) shows panorama video 500 on which color correction was performed using the input image I₁ of Table 1 as an optimum reference image, and FIG. 5(b) shows panorama video 510 on which color correction was performed using the input image I₅ of Table 1 as an optimum reference image candidate. FIG. 5(c) shows panorama video 520 on which color correction was performed using the input image I₄ of Table 1 as an optimum reference image candidate.

In FIG. 5, the panorama video 500 on which color correction was performed using the input image I₁ having the smallest standard deviation difference value D as an optimum reference image showed the worst image quality. The panorama video 510 on which color correction was performed using the input image I₅, having the greatest standard deviation difference value D, but having an edge preservation value and a value indicative of a percentage change in the saturation of color that do not satisfy the set thresholds, as an optimum reference image had a saturated region. In contrast, the panorama video 520 on which color correction was performed using the selected image I₄ as the final reference image according to the present invention showed the best image quality.

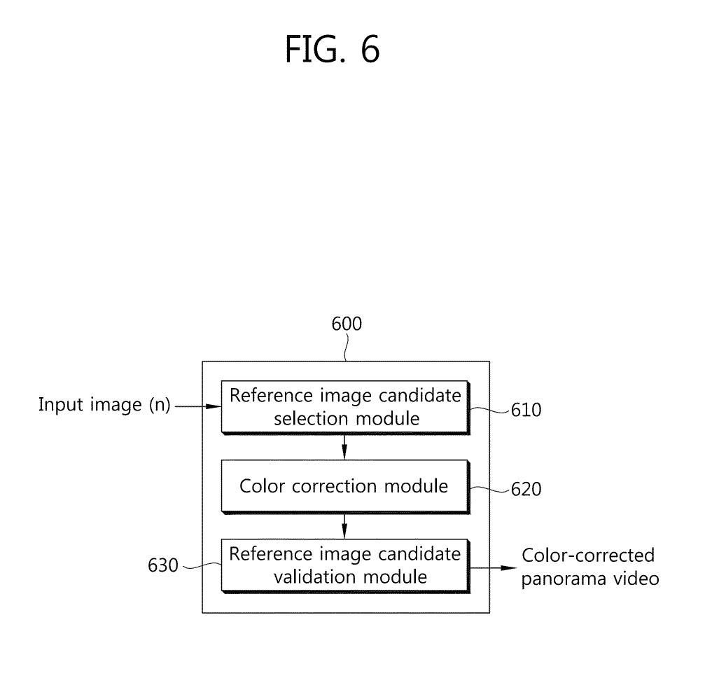

FIG. 6 is a block diagram schematically showing the color correction apparatus for performing color correction using a reference image when generating (stitching or registering) panorama video in accordance with an embodiment of the present invention.

Referring to FIG. 6, the color correction apparatus 600 includes a reference image candidate selection module 610, a color correction module 620, and a reference image candidate validation module 630.

The reference image candidate selection module 610 selects an optimum reference image candidate from input images for generating panorama video when the input images are received.

More particularly, the reference image candidate selection module 610 can calculate standard deviations for overlapping regions between the input images according to Equation 1 and calculate standard deviation difference values for the respective input images based on the standard deviations according to Equation 2. The reference image candidate selection module 610 can select an optimum reference image candidate based on the standard deviation difference values.

For example, the reference image candidate selection module 610 can rank the suitability of the input images for selecting an optimum reference image candidate based on the standard deviation difference values for the input images. An image having the greatest standard deviation difference value can be ranked as a reference image candidate having the highest suitability, or an input image having the smallest standard deviation difference value can be ranked as a reference image candidate having the lowest suitability. Order that an input image is selected as an optimum reference image candidate can be determined according to the suitability ranks of the input images.

The color correction module 620 performs color correction on the input images using the optimum reference image candidate.

Here, the colors of the remaining input images can be corrected on the basis of the color of the optimum reference image candidate using various color correction methods as described above. For example, a global color correction method, a local color correction method, a parametric-based color correction method, or a non-parametric-based color correction method can be used to correct the colors of the remaining input images.

The reference image candidate validation module 630 validates the optimum reference image candidate using the color-corrected input images. That is, the reference image candidate validation module 630 validates whether or not to use the optimum reference image candidate as the final reference image based on a comparison value obtained by comparing the color-corrected input images with the original input images (i.e., input images prior to color correction performed by the color correction module 620).

The comparison value, as described above, may be at least one of a contrast value, an edge preservation value, and a value indicative of a percentage change in the saturation of color value between the color-corrected input images and the original input images.

More particularly, the reference image candidate validation module 630 can derive a comparison value including at least one of a contrast value, an edge preservation value, and a value indicative of a percentage change in the saturation of color value and determine whether or not the comparison value satisfies a predetermined threshold.

If, as a result of the determination, it is determined that the comparison value satisfies the predetermined threshold, the reference image candidate validation module 630 can determines a current optimum reference image candidate to be the final reference image candidate. If, as a result of the determination, it is determined that the comparison value does not satisfy the predetermined threshold, the reference image candidate validation module 630 can select a next optimum reference image candidate from the input images based on the standard deviation difference values and validate the next optimum reference image candidate.

If the final reference image is not derived, that is, if any optimum reference image candidate does not satisfy the predetermined threshold, the reference image candidate validation module 630 may change the predetermined threshold and validate an optimum reference image candidate again based on the changed threshold.

When the final reference image is determined through the above-described process, the reference image candidate validation module 630 can derive panorama video whose color has been corrected using the final reference image.

A method of validating an optimum reference image candidate using comparison values if an edge preservation value and a value indicative of a percentage change in the saturation of color have been derived as the comparison values has been described in detail above, and a description thereof is omitted.

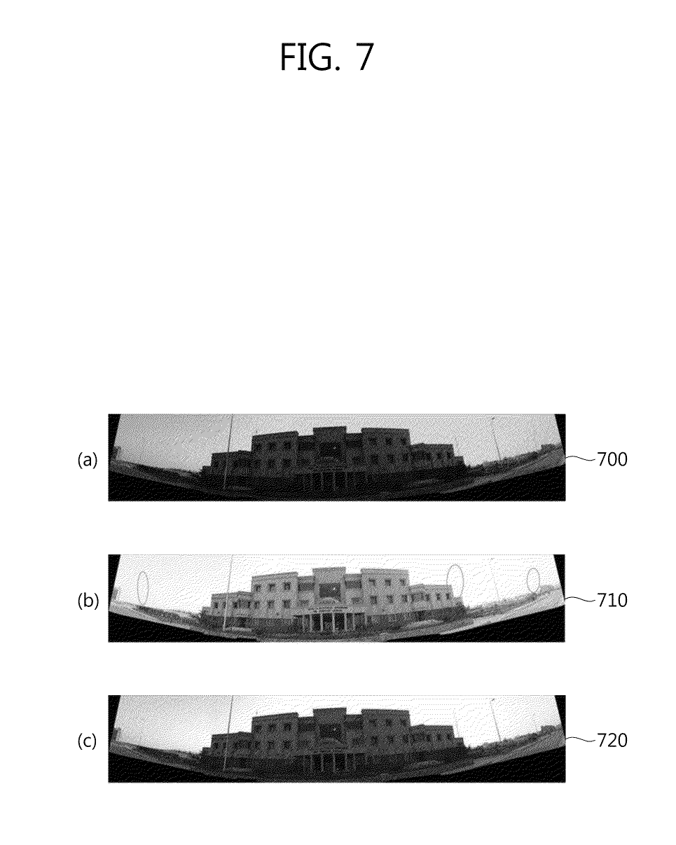

FIG. 7 is a diagram showing panorama video whose color has been corrected depending on the selection of a reference image.

FIG. 7(a) shows panorama video 700 on which color correction was performed using a reference image when an image having low brightness and low contrast was selected as the reference image. It can be seen that a dark image is generally shown in this panorama video 700 on which color correction was performed.

FIG. 7(b) shows panorama video 710 on which color correction was performed using a reference image when a saturated image was selected as the reference image. It can be seen that edge parts of objects, such as streetlights, are not clearly distinguished in this panorama video 710 on which color correction was performed.

FIG. 7(c) shows panorama video 720 on which color correction was performed using a reference image selected according to the present invention. It can be seen that the panorama video 720 clearly represents edge parts and also well represents a sense of color in the afternoon.

A color correction effect for input images can be improved because an optimum reference image is selected from the input images when stitching panorama video. Panorama video having the best quality can be obtained by the improved color correction effect. Furthermore, an optimum reference image can be automatically selected even without an interaction with a user when stitching panorama video.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The above-described embodiments include various aspects of examples. Although all kinds of possible combinations for representing the various aspects may not be described, a person having ordinary skill in the art will understand that other possible combinations are possible. Accordingly, the present invention should be construed as including all other replacements, modifications, and changes which fall within the scope of the claims.

What is claimed is:

1. A method of selecting a reference image for color correction when stitching panorama video based on input images, the method comprising:
selecting an optimum reference image candidate from the input images based on standard deviations for overlapping regions between the input images;
performing color correction on the input images based on the optimum reference image candidate; and
validating the optimum reference image candidate based on the color-corrected input images.

2. The method of claim 1, wherein the validating of the optimum reference image candidate comprises:
deriving a comparison value between the color-corrected input images and the input images prior to the color correction; and
determining the optimum reference image candidate to be a final reference image depending on whether or not the comparison value satisfies a predetermined threshold,
wherein the comparison value comprises at least one of a contrast value, an edge preservation value, and a value indicative of a percentage change in a saturation of color between the color-corrected input images and the input images prior to the color correction.

3. The method of claim 2, further comprising selecting a next optimum reference image candidate from the input images based on the standard deviation if, as a result of the determination, it is determined that the comparison value does not satisfy the predetermined threshold.

4. The method of claim 2, further comprising changing the predetermined threshold if the final reference image is not present in the input images and deriving the final reference image based on the changed threshold.

5. The method of claim 1, wherein the selecting of the optimum reference image candidate comprises:
calculating a standard deviation for an overlapping region between two neighboring input images after geometric correction is performed on the input images;
calculating a standard deviation difference value for each of the input images based on the standard deviation; and
ranking a suitability of the input images for selecting the optimum reference image candidate based on the standard deviation difference value.

6. The method of claim 5, wherein the selecting of the optimum reference image candidate comprises selecting an input image having a maximum value, from among the standard deviation difference values for the input images, as the optimum reference image candidate.

7. The method of claim 5, wherein the ranking of the suitability of the input images comprises determining order of the suitability of the input images in descending powers of the standard deviation difference values.

8. The method of claim 1, wherein the input images comprise images having different views obtained by multiple cameras.

9. A color correction apparatus for performing color correction when stitching panorama video based on input images, the apparatus comprising:
a reference image candidate selection module for selecting an optimum reference image candidate from the input images based on standard deviations for overlapping regions between the input images;
a color correction module for performing color correction on the input images based on the optimum reference image candidate; and
a reference image candidate validation module for validating the optimum reference image candidate based on the color-corrected input images.

10. The color correction apparatus of claim 9, wherein the reference image candidate validation module derives a comparison value between the color-corrected input images and the input images prior to the color correction and determines the optimum reference image candidate to be a final reference image depending on whether or not the comparison value satisfies a predetermined threshold,
wherein the comparison value comprises at least one of a contrast value, an edge preservation value, and a value indicative of a percentage change in a saturation of color between the color-corrected input images and the input images prior to the color correction.

11. The color correction apparatus of claim 10, wherein the reference image candidate validation module selects a next optimum reference image candidate from the input images based on the standard deviation if, as a result of the determination, it is determined that the comparison value does not satisfy the predetermined threshold.

12. The color correction apparatus of claim 10, wherein the reference image candidate validation module changes the predetermined threshold if the final reference image is not present in the input images and derives the final reference image based on the changed threshold.

13. The color correction apparatus of claim 9, wherein the reference image candidate selection module calculates a standard deviation for an overlapping region between two neighboring input images after geometric correction is performed on the input images, calculates a standard deviation difference value for each of the input images based on the standard deviation, and ranks a suitability of the input images for selecting the optimum reference image candidate based on the standard deviation difference value.

14. The color correction apparatus of claim 13, wherein the reference image candidate selection module selects an input image having a maximum value, from among the standard deviation difference values for the input images, as the optimum reference image candidate.

15. The color correction apparatus of claim 13, wherein the reference image candidate selection module determines order of the suitability of the input images in descending powers of the standard deviation difference values.

16. The color correction apparatus of claim 9, wherein the input images comprise images having different views obtained by multiple cameras.
